(19) United States
(12) Patent Application Publication
(10) Pub. No.: US 2006/0118481 A1
(43) Pub. Date: Jun. 8, 2006

(54) Mehods and apparatuses for filtering

(76) Inventor: Lawrence Marc Trachtenbroit, New York, NY (US)

Correspondence Address: NORA M. TOCUPS, P.O BOX 698, 140 PINECREST AVE, DECATUR, GA, 30030, US

(21) Appl. No.: 11/336,049

(22) Filed: Jan. 20, 2006

Related U.S. Application Data
(63) Continuation-in-part of application No. 10/839,519, filed on May 5, 2004.
(60) Provisional application No. 60/523,838, filed on Nov. 20, 2003.

(51) Int. Cl. B01D 33/01

(52) U.S. Cl. 210/470; 210/497.01

(57) ABSTRACT

A filter for use in a container containing liquid and particles. The filter includes a cup that fits in the container. The cup includes a sidewall having in its bottom half material for filtering. The cup has a gasket around its top to create a seal between the cup and container. The filter may include a rod to insert and remove the cup, and the rod may be detachably attached to a positioning mechanism in the inside bottom of the cup. The rod may include a handle with an indicator surface for display of information. The cup with rod may be sized to fit within the container, and sized to allow for a cover over the container without interference.

### CROSS-REFERENCE TO RELATED APPLICATION

The present application claims priority to and benefit of the prior filed co-pending and commonly owned provisional patent application, filed in the United States Patent and Trademark Office on Nov. 20th, 2003, assigned Ser. No. 60/523,838, and incorporated herein by reference, and the prior filed co-pending and commonly owned patent application, filed in the Untied States Patent and Trademark Office on May 5, 2004, assigned Ser. No. 10/839,519, and incorporated herein by reference.

### FIELD OF THE INVENTIONS

The inventions relate generally to liquid filtration devices, and more particularly relate to devices that may be used to brew beverages and other liquid food products.

### BACKGROUND OF THE INVENTIONS

With the evolution of specialty coffee, tea and other beverages, consumers are expecting and demanding a greater selection of beverages that are of high quality, inexpensive, made to order, and are convenient when and where they want to enjoy them.

Restaurants and specialty coffee and tea shops typically brew their beverages in advance with traditional brewing systems that brew by delivering boiling or near boiling water over a bed of coffee grounds or tea leaves. The water flows through the grounds or leaves extracting the flavors, and then may flow through a paper or other filter into a thermal carafe or similar type container.

Generally, restaurants and specialty shops brew beverages in amounts that correspond to anticipated customers. Brewed beverages, however, cannot be stored indefinitely until the anticipated customers materialize. Coffee and other high quality beverages generally begin to deteriorate thirty minutes from being brewed. Some establishments continue to serve the brewed beverages even after the quality has begun to deteriorate. Many high-end restaurants, specialty shops, and convenience stores have adopted a procedure of brewing a new pot of coffee or tea every 20-30 minutes, discarding the previous pot. The waste resulting from this procedure is typically reflected in the price of the coffee or tea charged to customers at the high end restaurants and specialty shops. Other establishments take steps to minimize the waste and extra cost that may result from brewing more than needed for customers. These steps may include limiting the quantity and selection of types or flavors of brewed beverages that are available.

There is a need, therefore, for a way for restaurants, specialty shops, and other establishments to offer customers a wide selection of types and flavors of brewed beverages of high quality without the risks and costs associated with brewing too much or too many brewed beverages.

Some higher end restaurants avoid the problems discussed above by serving their customers coffee brewed by using the French press brewing system. Many consumers use this system as well. The French press brewing system is considered by many to be the “premier” method of brewing a high quality beverage. The French press brewing system is considered to result in coffee having a great flavor and consistency due, in part at least, to control of the extraction time and delivery of all of the oils that are often trapped in the paper filters of traditional brewing devices.

There is a French press in the French press brewing system. A French press typically includes a container of rigid material such as glass, metal, or plastic. Coffee of “coarse” grind is measured into the container and near-boiling water is poured over the grounds. After a period to allow for brewing, a plunger unit is inserted into the container and pushed through contents of the container so the brewed liquid is filtered and separated from the coffee grounds. The coffee grounds are trapped at the bottom of the container. The coffee may be poured from a spout in the container into a cup, mug, or other individual serving unit.

Even though the coffee, or tea or other brewed beverages, brewed according to the French press brewing system is considered by many to be excellent, the system presents several drawbacks. A first drawback is that a consumer who desires a cup of French press brewed coffee must own or have access to a French press brewing system. In other words, the consumer (or other person at the consumer's place of access) must invest in the French press brewing system by purchasing the French press equipment including container and plunger. Another drawback is that a French press brewing system typically is sized to deliver several cups of coffee. Even if a consumer desires only a single cup of coffee, he or she may have to use a French press brewing system sized for more than one cup. The consumer may be able to brew only a cup of coffee in that system, but measurements may be difficult to make and procedures may be difficult to follow to obtain an excellent single serving of French press coffee. Another drawback is that the French press brewing system requires the time and effort of the consumer in cleaning of at least the container and plunger between uses. The grounds and any remaining oils have to be washed out of the container as well as the plunger in the French press brewing system.

The previously mentioned disadvantages of the French press brewing system including necessity of investment in the equipment, the size of the equipment relative to a single serving, and the necessity of cleaning the equipment contribute to a final disadvantage of the French press brewing system mentioned here. That disadvantage is the relative lack of mobility of the French press brewing system. Given the cost of the system, its size, and need for cleaning, the French press brewing system is not readily transportable by a consumer. Thus, the convenience of the French press brewing system is limited.

Another device that may be used to brew coffee, tea or other beverages is referred to herein as a “press pot”. The press pot has gained popularity in the kitchen as a useful straining tool in the preparation of soups, sauces as well as other creative culinary visions. Like the French press brewing system, a press pot has a container into which a plunger is inserted. The plunger may or may not include a filter or straining device.

A press pot, however, has uses other than brewing, and thus, may lack certain features that are convenient or even necessary for brewed beverages, and may include other features that pose a problem for the brewing of beverages. For example, a press pot may not include a spout in its container. To remove the contents from a press pot's container, the contents may be simply poured out over the sides of the press pot or out through a small opening in the press pot's cover. As another example, the plunger of the press pot may not necessarily keep the coffee grounds, tea leaves, or other flavoring residue separate from the brewed liquid. A consumer pouring a cup of coffee from the press pot may pour coffee grounds into his or her cup or mug as well as the brewed beverage.

Further, a press pot generally includes a cap or cover for its container. Once the plunger is pressed into the contents of the container, the cap usually “locks” to cover the top of the container. It may be difficult to recover the brewed beverage from the press pot through a hole or other opening in the press pot's cover, especially if the handle of the plunger protrudes through the same opening in the cover of the press pot.

The press pot has at least a disadvantage in common with the French press brewing system. Like the French press brewing system, a press pot requires the time and effort of the consumer in cleaning the press pot's equipment between uses.

As noted, the popularity of the use of press pots has grown among consumers. Thus, a drawback of the press pot for brewing beverages is that it may be in demand for other uses. A consumer may need to have two or three press pots on hand to have a press pot available for brewing beverages as well as for other uses such as in cooking.

If a press pot is used for brewing coffee, it is usually designed to brew four or more cups of coffee at a time. There have been some attempts to create a press pot to brew an individual cup of coffee. However, such press pots remain difficult to clean. There have been some attempts in the market to create a disposable press pot for individual use. However, the patented designs that have been disclosed are considered to be costly to manufacture and of impractical designs.

Another type of device used to brew beverages is referred to herein as the “whole cup-size strainer” or simply “strainer”. Coffee grounds, tea leaves, or other flavorings are placed into a container. Hot water (or other liquid) is poured into the container and allowed to brew. To allow the consumer to drink the brewed beverage without the coffee grounds, tea leaves, or other flavoring residue, a strainer shaped like the container, but smaller, is inserted into the container. The strainer nestles into the container, filters the brewed liquid, and separates it from the coffee grounds, tea leaves, or other flavoring residue. The consumer may drink the beverage from the container with the strainer in place, or, with the strainer in place, may pour the beverage into a cup, mug, or other serving piece.

Like the other brewing devices mentioned, the whole cup-size strainer has drawbacks. To strain the flavoring residue effectively, the whole cup-size strainer must be specially made to substantially match the inside of the container with which it is to be used. One disclosed design is a whole cup-size strainer that fits into an individual serving size cup. This design is considered to be costly to manufacture. Another drawback of the whole cup-size strainer is that it may be easily misused. If the whole cup-size strainer is forced too quickly or forcefully into the liquid with the brewing materials, the whole-cup size strainer may force a portion, even a large portion, of the contents out of the container, which may cause burns from the hot liquid as well as creating a mess.

In sum, there is a need for a way for consumers to conveniently and easily make or obtain a single-serving of a high quality brewed beverage from among a wide selection of flavors and types of such beverages. There is a need for a way for consumers to make or obtain the high quality brewed beverage without investment in expensive equipment or multiple sets of equipment, without having to make large quantities of the brewed beverage, and without having to clean the equipment.

### SUMMARY

Generally, the inventions relate to methods and apparatuses that allow for the brewing of a beverage with flavoring particles and that allow for the consumption of the beverage without the flavoring particles.

Advantageously, the inventions provide a way for restaurants, specialty shops, convenience stores, and other establishments to offer customers a wide selection of types and flavors of brewed beverages of high quality without the risks and costs associated with brewing too much or too many brewed beverages. The inventions also provide a way for consumers to conveniently and easily make or obtain a single-serving of a high quality brewed beverage from among a wide selection of flavors and types of such beverages. In addition, the inventions provide a way for consumers to make or obtain the high quality brewed beverage without investment in expensive equipment or multiple sets of equipment, without having to make large quantities of the brewed beverage, and without having to clean the equipment.

There are many possible embodiments of the inventions. An exemplary embodiment is a filter for use in a container containing a liquid and particles in the liquid. The filter includes a cup sized to fit within the container. The cup includes material for filtering substantially all of the particles from the liquid and keeping substantially all of the filtered particles separated from the liquid. The cup also has a gasket disposed around the top of the cup for creating a seal between the cup and the inside side surface of the container. The gasket may be integrally formed with the cup. In addition, the filter may include a rod with one end of the rod attached generally perpendicularly to the inside top and substantially center of the bottom of the cup. The rod may be used to insert the cup into and remove the cup from the container. Detached from the cup, the rod may be used to stir the contents of the container or otherwise.

More particularly, the exemplary embodiment of the filter introduced in the previous paragraph may include other features such as a cup with a sidewall including material for filtering. The cup may include at least a sidewall connected to the bottom of the cup with only the sidewall including the material for filtering or only the bottom half of the sidewall including the material for filtering. The sidewall of the cup may be a generally cylindrical sidewall tapering slightly inward from the gasket of the cup to the bottom of the cup. The material for filtering may be included in the bottom half of the side wall of the cup between supports set between the top half of the side wall of the cup and the bottom of the cup. The material for filtering may include at least two segments. The supports set between the top half of the generally cylindrical side wall of the cup and the bottom of the cup may include at least two supports. The two segments of the material for filtering may be included, respectively, between the at least two supports.

In addition, in the exemplary embodiment, the cup may include a positioning mechanism on the inside top and substantially center of the bottom of the filter cup for generally perpendicular attachment of one end of the rod. The positioning mechanism may include a female device for receipt of a male device on the one end of the rod. The rod may include a handle at the end opposite to the end of the rod attached to the bottom of the cup with the handle having an indicator surface for display of information. The rod may be removable from the cup.

In the exemplary embodiment, the cup with the attached rod may be sized in a variety of ways. For example, the cup with the attached rod may be sized to fit within the container. As another example, the cup with the attached rod may be sized so that the cup with the attached rod in the container allows for placement of a cover over the container without interference from the rod and/or attached rod.

Another exemplary embodiment of the inventions is an apparatus for filtering a fluid of a substance. The apparatus may include a cup including a generally cylindrical sidewall connected to a bottom. The sidewall may taper slightly outwardly away from the bottom towards the top of the sidewall. The sidewall of the cup may include filter material set in at least part of the bottom part of the sidewall. The insertion of the cup into the fluid including the substance filters the fluid of the substance by the cup allowing the fluid, but not the substance to pass through the filter material. The cup may include a gasket disposed around the top of the sidewall of the cup. The apparatus also may include a plunger removeably attached to the inside top of the bottom of the cup.

Yet another exemplary embodiment of the inventions provides a filter for use in brewing a beverage from liquid and a brewing substance. The filter includes a device for separating the brewing substance from the liquid. The device includes a bottom attached to a collar. The collar frames at least one segment of filter material. A plunger is attached to the inside top of the bottom of the device and may be used for inserting the device into the liquid and removing the device from the liquid. Advantageously, the plunger allows for such insertion and removal without the hand holding the plunger touching the liquid or the beverage. The plunger may be detachable.

Advantageously, the inventions allow restaurants, cafes, convenience stores, and other vendors to offer filtered beverages. For example, a consumer may purchase a single-size serving of hot tea, and be provided with a cup containing tea leaves. Hot water may be poured into the cup, and time allowed for brewing the tea. As part of the purchase, the consumer may be provided with a filter or apparatus. Once the tea has brewed, the consumer may insert the filter or apparatus into the liquid so the filter or apparatus filters and separates the tea leaves from the liquid now referred to as tea. The consumer then may enjoy the tea without hindrance by the tea leaves.

Other features and advantages of the inventions may be more clearly understood and appreciated from a review of the following detailed description and by reference to the appended drawings and claims.

### BRIEF DESCRIPTION OF THE DRAWINGS

FIG. 1 illustrates an exemplary filter apparatus in a container.

FIGS. 2A-2D illustrate exemplary configurations of a gasket as may be used with a filter in an exemplary filter apparatus.

FIGS. 3A-3G illustrate exemplary filters as may be used with an exemplary embodiment.

FIG. 4 illustrates an exemplary embodiment of a filter apparatus.

FIGS. 5A-5C illustrate exemplary elements that may be included in an exemplary embodiment of the inventions.

FIG. 6 illustrates an exemplary embodiment of the inventions in use with a container.

FIG. 7 illustrates an exemplary embodiment of the inventions in use with a container with a cover.

### DETAILED DESCRIPTION

In a brewed beverage, such as coffee or tea, the coffee grounds or tea leaves are usually separated from the brewed liquid before consumption. The inventions relate to methods and apparatuses for separating the coffee grounds or tea leaves from the brewed liquid. In addition to coffee or tea, the inventions may be used with other beverages, other liquids, fluids, and may even be used with other substances. A liquid may also be referred to herein as a beverage, brewed beverage, fluid, and by like terms. A substance such as the coffee grounds or tea leaves that may be present in the liquid to give it flavor may be referred to herein as particles, flavor particles, brewing residue, or flavor or flavoring residue, or like terms.

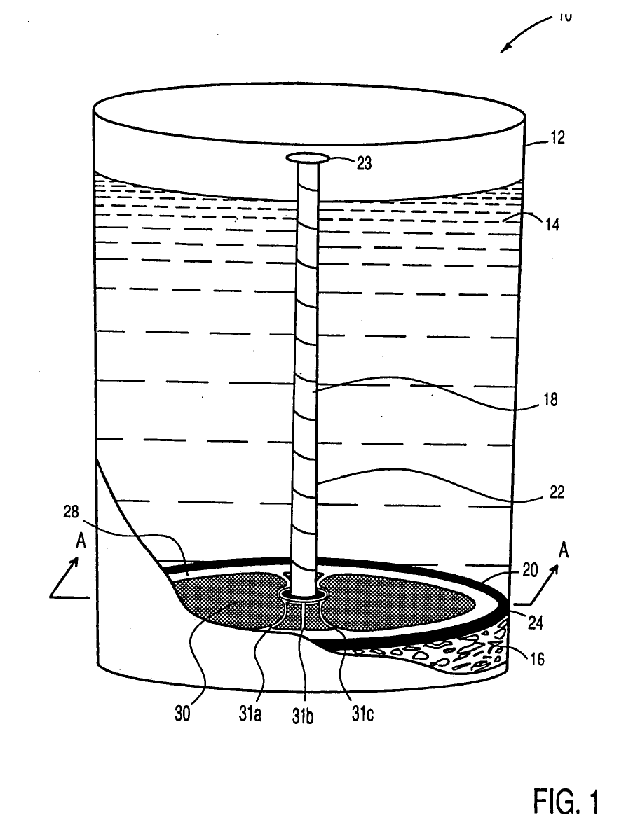

FIG. 1 illustrates an environment 10 including a container 12 filled with a liquid 14 that has been filtered of particles 16 (such as coffee grounds, tea leaves, or other flavoring residue) by an exemplary embodiment 18 of the inventions that keeps the particles 16 separate from the liquid 14. The exemplary embodiment 18 may be referred to as a filtration device, filtrative device, filter device or apparatus, filter/separation device, or filtration/separation device.

Advantageously, the filter apparatus 18 may be used with a container 12 that allows for a single-serving, but the filter apparatus 18 also may be sized for containers of more than one serving. A container may be or may be referred to as a cup, a “first” cup, a glass, a mug, a pot, a carafe, a vessel, or the like. Moreover, the container 12 may be disposable such as after a one-time use, or may be re-usable. The container 12 may be constructed of almost any appropriate material including paper, plastic, etc. The illustrated container 12 is generally cylindrical, but does not necessarily have to be. For example, to allow for stacking of similar containers, the container may have a generally cylindrical form, but be slightly tapered from larger in diameter at the top to smaller at the bottom, or the container may be cone-shaped.

Another advantage of the filter apparatus 18 is that it may be used as a filter/separation device (with appropriate configuration) with most types or kinds of liquids. The liquids most often referenced herein are beverages such as coffee and tea, but the filter apparatus 18 may be used with other liquids, and may even be used with other substances in certain circumstances.

Further, even though the exemplary embodiment 18 is referred to as a “filter”, “filter/separator” apparatus, or something similar, the exemplary embodiment 18 may be used in situations that do not include nor require any “filter” and/or “separation” functions. For example, the exemplary embodiment 18 and other embodiments may be used as a sort of “strainer” with a liquid or other substance of varying consistency to achieve a more even consistency throughout the liquid or other substance. Moreover, the exemplary embodiment and other embodiments may be used with a container when no “filter” or “separation” functions are carried out.

Generally, the examples provided herein refer to the liquid 14 as a single type of liquid like coffee or tea. Nevertheless, the liquid 14 may be of more than one type or may be a mix. Also, the examples herein refer to the particles 16 as a single type of particle such as coffee grounds or tea leaves. As with the liquid 14, the particles 16 may be of more than one type or may be a mix of types. In addition, the examples herein refer to particles 16 that “flavor” a liquid such as coffee grounds, tea leaves, etc. The inventions are not limited to use with such particles, but may be used with particles that do not “flavor” a liquid.

FIG. 1 illustrates the filter apparatus 18 as including a filter 20 that may be separably attached to one end of a rod 22. The rod 22 may be used to insert and move the filter 20 into the container 12. The rod 22 may include a handle 23 at its end opposite the filter 20 to aid in the use of the filter apparatus 18. As the filter 20 is moved into the container 12 from the top towards the bottom of the container 12, the filter 20 separates the particles 16 from the liquid 14 as the filter 20 is moved through the liquid 14. The separably attached rod 22 may be removed from filter 20 after the filter 20 is inserted into the container (or otherwise). The rod 22 may be used as a tool to stir the liquid. Additional information about the rod 22 and the handle 23 is provided below following the immediate discussion relating to the filter 20.

In the exemplary embodiment, the filter 20 is a filter disc substantially flat on both sides and relatively thin in vertical cross section. The flatness and the thinness of the filter disc may aid to minimize the amount of space taken up by the filter disc in the container. By taking up less space, the filter apparatus allows for more liquid, beverage or other content in the container. The thinness of the filter disc may depend on the content and/or manner of its construction. For example, the filter disc may be no thicker than necessary to allow for a filtering and a separation function.

Even though exemplary filters illustrated and discussed herein are generally shaped as “discs”, the filter of the filter apparatus should not be so limited. For example, an alternate filter may have a convex and/or concave (rather than flat) shape. Another alternative filter may have a cup-like shape that conforms generally to the or part of the inner surface of the container. Further, a filter also maybe referred to as a strainer, separator, sieve, purifier, sifter, winnower, screener, or like term.

To filter substantially all of the particles 16 from the liquid 14 and to keep at least most of the filtered particles 16 separate from the liquid 14, the filter 20 is sized and shaped generally in horizontal cross section to fit within the container 12. The filter 20 is sized and shaped generally to create a seal with the inside of the container at some point on the inside side surface of the container 12. An alternate embodiment of the inventions, discussed below, may include a gasket, sealing ring, collar, a cylindrical attachment or other element(s) around the filter 20 to create, effect, support, or maintain the seal with the inside of the container 12.

Advantageously, the match or seal between the filter 20 and the inside side surface of the container 12 is maintained even as the filter apparatus 18 is moved further into and towards the bottom of the container 12. As the filter 20 moves through the liquid filtering particles, the filtered particles 16 are trapped underneath the filter 20 of the filter apparatus 18. Advantageously, by use of the filter apparatus 18, a consumer may drink a brewed beverage without interference from the residue of the brewing process.

To create the seal between the filter 20 and the inside of the container, the filter 20 may be of a size and shape that substantially corresponds to the inside of a horizontal cross section of the container. For example, if the container 12 is generally cylindrical, then the filter may be circular and may have a size that fits just within the container 12. As another example, if the container 12 is generally cylindrical, but larger at the top than at the bottom, the filter 20 may be circular and may be of a size sufficient to separate substantially all of the particles 16 as the filter 20 is moved from the top to the bottom of the container; but yet, the filter 20 may fit as far into the container as nearly to the inside bottom of the container.

How far the filter fits into the container may depend, at least in part, on the size, amount, and/or other characteristics of the filtered particles as well as other elements in the environment. Thus, the space below the inserted filter apparatus may be a variable space. The ability to vary the space between the bottom inside of the container and the filter is an advantage. Such variance allows for the filter apparatus to be used in different circumstances as possibly determined by the filter size, by the container, and/or by the consumer, so as to accommodate different amounts, types, grinds or other differences of brewing materials. For example, a consumer may prefer a strong cup of coffee and the space under the filter may need to be greater than for a weak cup of coffee to accommodate an adequate amount of coffee grounds used to brew the strong cup of coffee.

The filter apparatus 18 may be inserted into the container 12 and moved towards the bottom of the container 12 until the filter apparatus 18 does not move any further towards the bottom. This position of the filter apparatus 18 is referred to as the “fully inserted” position. In this position, substantially all of the particles have been filtered from the liquid and are trapped underneath the filter 20 of the filter apparatus 18. Advantageously, the filter apparatus 18 may compress or be made to compress the filtered particles 16 towards the bottom of the container 12 to obtain as much filtered liquid 14 as possible.

Another advantage of the inventions is that the exemplary filter apparatus 18 may be used to obtain filtered liquid 14 without full insertion of the filter apparatus 18 into the container 12. This advantage is derived at least in part from the configuration of the filter 20 with respect to the inside side surface of the container 12. As noted above, the filter 20 generally is sized to fit just within the inside side surface of the container 12. Once the filter apparatus 18 is inserted into the container 12, the filter 20 generally matches the inside side surface of the container 12. This match creates a seal that generally does not allow particles 16 to pass between the filter 20 and the inside side surface of the container 12. Even if the filter apparatus 18 is only partially inserted into the liquid 14, generally no particle or few particles avoid the filter function of the filter 20. Thus, liquid 14 that is filtered by the filter apparatus 18, even if it is only partially inserted, is generally free from particles 16. As a result, a consumer may be able to consume or obtain at least some filtered liquid 16 even if the filter apparatus 18 is inserted only at least partially into the liquid 14. This partial insertion may be useful to a consumer to test whether enough brewing has occurred to the consumer's satisfaction without having to completely insert the filter apparatus 18.

In an alternative embodiment, the filter apparatus and the container may be configured with respect to each other in a way that provides for a “resting place” of the filter apparatus within the container. With the filter apparatus in the resting place, it may be more difficult to remove the filter apparatus from the container than if the filter apparatus is otherwise positioned in the container. The added difficulty, even if only slight, in removal of the filter apparatus aids in the consumption or removal of the liquid from the container without interference by the filter apparatus and/or whatever it has trapped.

For example, the filter of the filter apparatus may be sized to form a relative seal or match with the inside side surface of the container once the filter apparatus is inserted into the container, even if the insertion is only partial. Yet, at a specified place within the container such as at a set distance from the bottom of the container, (such as the “fully inserted position”), a relationship may be created between the filter of the filter apparatus and the inside side surface of the container that results in a specific fit between the filter and the inside side surface. When the filter is specifically fitted with the inside side surface of the container, the filter apparatus is said to be in its resting place.

The resting place of the filter apparatus with the specific fit between the filter and the inside side surface of the container may be achieved in a number of different ways. For example, the filter may more tightly fit the inside side surface at the resting place than at any other place with respect to the inside side surface of the container. The tight fit may be the result of a greater seal or match between the filter and the inside side surface of the container at the resting place than elsewhere.

As another example, the specific fit may be the result of tongue and groove connection or the like or other connection between the filter and the inside side surface of the container. For example, a container may include a groove at a particular point on its inside side surface. The filter may be sized to fit into the groove to form the specific fit. A groove also may be referred to as a notch, path, track, or like term.

As additional example, the specific fit may be achieved by the interaction between the filter and a stop or ridge disposed on the inside side surface of the container. For example, a ridge protruding towards the center of the container from the inside surface of the container may be disposed near the bottom inside of the container. The ridge generally is of a size to stop or make more difficult further movement of the filter towards the bottom inside of the container. Effectively, the filter “sits on top” of the ridge and the specific fit is created between the filter and the inside side surface of the container.

The filter apparatus 18 may be constructed to include additional elements to help create or to supplement the match or seal between the filter 20 and the inside side surface of the container 12. As illustrated in FIG. 1, the exemplary embodiment of the filter apparatus 18 includes such an optional additional element. This additional element may be referred to as a gasket, a sealing ring, sealer, ring, or like term.

The exemplary filter apparatus 18 includes a gasket 24 disposed around the periphery of the filter 20. In embodiments of the filter apparatus 18 where a seal or match is not created or not created relatively tightly between the filter 20 and the inside side surface of the container 12, the gasket 24 may be used to create or to improve the match or seal. The gasket may be made of flexible rubber, rubber-like material, plastic, or other such bendable or flexible food-grade material that may create or improve a match or seal between the filter 20 and the inside side surface of the container 12. The gasket's composition also may ease insertion/withdrawal of the filter 20 with respect to the container 12 without compromising the filter's filtering function. For example, the gasket's composition may be more flexible than the composition of the filter 20. Further, the gasket 24 may be configured with the filter 20 and with respect to the inside of the container to create an embodiment of the specific fit described above.

The gasket 24 may take any number of forms as appropriate for its function with the filter and with respect to the inside of the container. Four examples of gasket 24 or its use are described below.

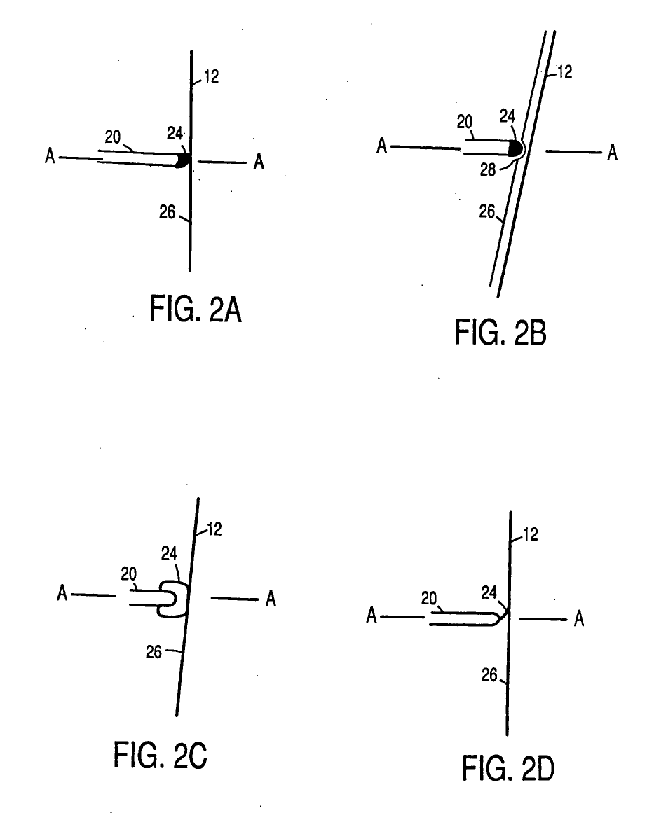

FIG. 2A illustrates the first gasket example with a partial cross section taken along “A” of part of the filter apparatus 18 inserted into container 12. The filter apparatus 18 includes the filter 20 with a gasket 24 disposed around its periphery. The gasket 24 may be simply an extension of the filter 20 so that the gasket 24 creates a seal with the inside side surface 26 of the container 12.

FIG. 2B illustrates the second gasket example with a partial cross section taken along “A” of part of the filter apparatus 18 inserted into container 12. The filter apparatus 18 includes the filter 20 with a gasket 24 disposed around its periphery. The gasket 24 may be an extension of the filter 20, and the gasket 24 may be shaped or configured to form an embodiment of the specific fit discussed above between the filter 20 and the inside side surface of the container 12. In the embodiment of FIG. 2B, the inside side surface 26 of the container 12 includes a groove 28. The gasket 24 may be configured to fit the groove 28 to form the specific fit between the filter and the inside side surface 26 of the container 12.

FIG. 2C illustrates the third gasket example with a partial cross section taken along “A” of part of the filter apparatus 18 inserted into container 12. The filter apparatus 18 includes the filter 20 with a gasket 24 disposed around its periphery. Further, the gasket 24 is disposed in vertical cross section in a substantially “C” shape with the filter 20 fitting into the center of the “C”. As illustrated, when the filter apparatus 18 is inserted into the container 12, the gasket 24 creates a seal or match between the filter 20 and the inside side surface 26 of the container 12.

Advantageously, the “C” shape of gasket 24 in FIG. 2A may be specifically configured to ease insertion of the filter apparatus 18 into the container 12. In addition, or alternatively, the “C” shape of gasket 24 may be specifically configured to make withdrawal of the filter apparatus 18 from its container 12 relatively difficult (or at least more difficult than insertion).

FIG. 2D illustrates the fourth gasket example with a partial cross section taken along “A” of part of the filter apparatus 18 inserted into container 12. The filter apparatus 18 includes the filter 20 with a gasket 24 disposed around its periphery. Further, the vertical cross section of this exemplary gasket 24 is a substantially flat shape, and may be thinner than the vertical cross section of the filter 20. The substantially flat shape of the gasket 24 and/or its composition may allow the gasket 24 to function similarly to a wiper blade. As illustrated, when the filter apparatus 18 is inserted into the container 12, the gasket 24 creates a seal or match between the filter 20 and the inside side surface 26 of the container 12.

As noted above, a function of the filter in the filter apparatus is to allow for passage of the liquid (or other substance) and to block passage of the particles. The filter may be constructed in many ways to accomplish this function. The filter 20 of the exemplary embodiment shown in FIG. 1 includes a frame 28 holding or supporting a filtering material 30. The exemplary frame 28 is generally wheel shaped with interior supporting arms such as arms 31a-c. The arms may add rigidity to the filter as well as hold or support the filtering material. In addition, the frame 28 may function to aid the filter 20 in withstanding the upward press of the liquid as the filter is moved through the liquid into the container 12. The frame 28 may be made of plastic or other food-grade material, such as paper, recycled paper, wood, cardboard, laminated paper, or the like.

As illustrated in FIG. 1, the filtering material 30 is supported by the frame 28 and supported by its arms such as arms 31a-c. The filtering material 30 may be made of a different substance than the frame 28. Alternatively, the filtering material may be integral with the frame. Further, the filtering material may vary in composition and other characteristics depending on the liquid, and/or the particles in the liquid. The filtering material may be a nylon mesh, perforated solid material, or other food-grade filtering mechanism.

For example, the filtering material may be chosen to filter a specific type of particle such as tea leaves, coffee grounds, etc. The filtering material 30 of the exemplary embodiment illustrated in FIG. 1 has a mesh configuration. The filtering material 30 may be of a finer mesh (smaller openings), or coarser mesh (larger openings) as appropriate to the liquid and particles to be filtered and/or separated.

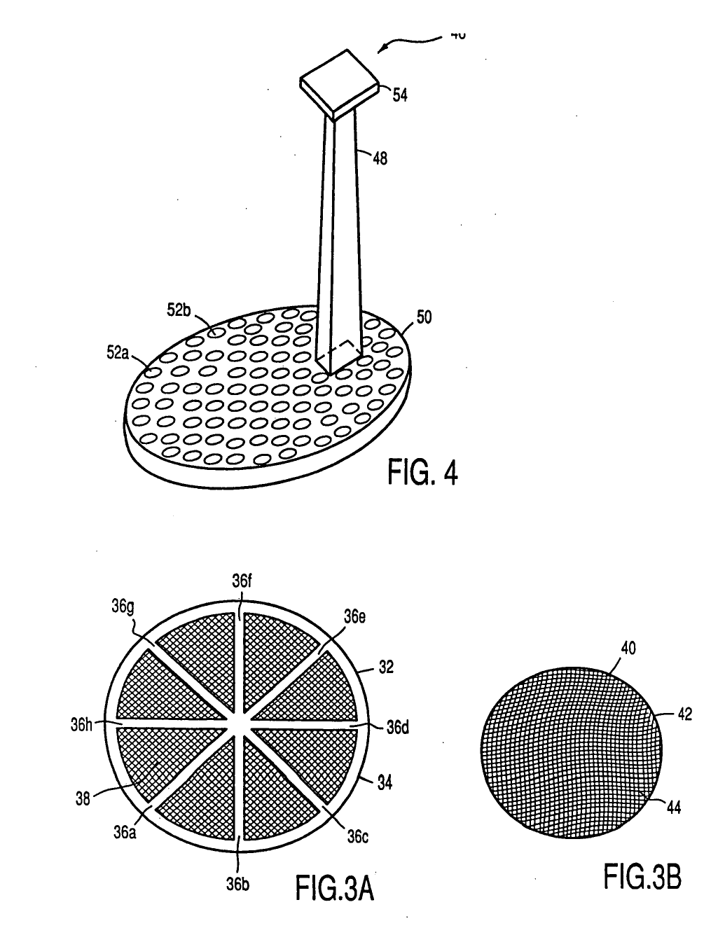

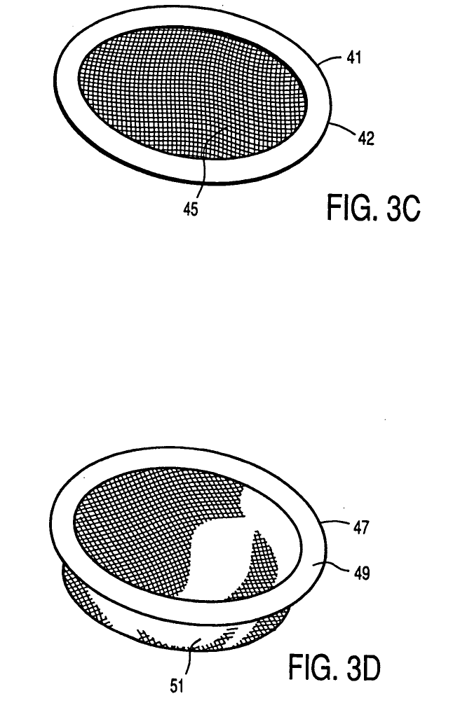

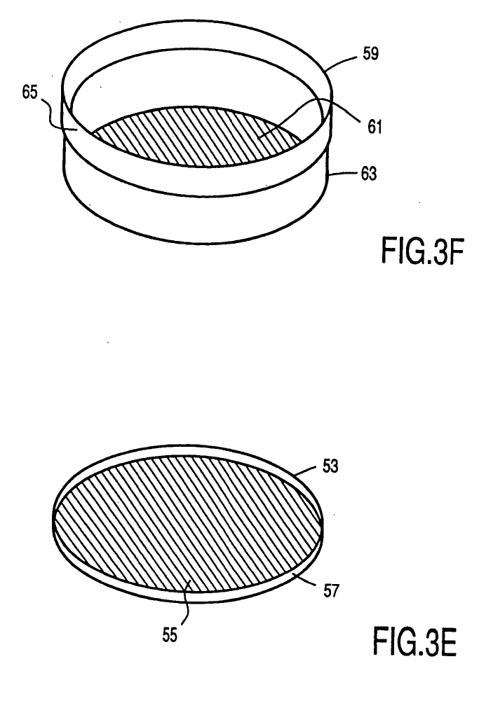

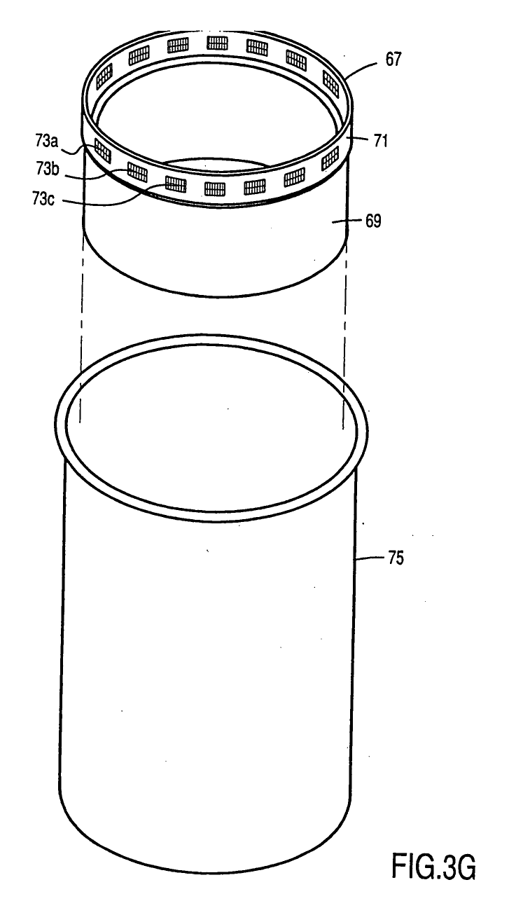

FIG. 3A illustrates a top view of another exemplary filter 32 that may be used as a filter or in a filter apparatus. The filter 32 includes a frame 34 that is generally wheel shaped and includes eight (8) symmetrical spokes 36a-h. A filtering material 38 in a mesh configuration is disposed between the spokes 36a-h and within the frame 23. Alternative configurations of the exemplary filter 32 will be apparent to those skilled in the art such as a configuration with a differently shaped frame, with more or less spokes, with different filter material, etc.

FIG. 3B illustrates a top view of yet another exemplary filter 40 as may be used with a container or with a filter apparatus. The filter 40 includes a peripheral frame 42 in the shape of a circle. The filter 40 also includes filtering material 44 that may be similar to the material of a conventional tea bag, and may appear almost cloth-like to the consumer. In an alternative embodiment, the filter 40 could be a perforated strainer device. As yet another alternative, the filter 40 may not include a peripheral frame, but be simply made up of a filtering material 44. Alternative configurations of the exemplary filter 40 will be apparent to those skilled in the art such as a configuration with a differently shaped frame, with different filter material, etc.

FIG. 3C illustrates a top view of yet another exemplary filter 41 that may be used in a filter apparatus or otherwise. The filter 41 includes a frame 43 that is generally circular, and may function as a gasket or a sealing ring. A filtering material 45 is set within the frame 43. Alternative configurations of the exemplary filter 41 will be apparent to those skilled in the art such as a configuration with a differently shaped frame, with different filter material, etc.

FIG. 3D illustrates a perspective view of another exemplary filter 47 that may be used in a filter apparatus or otherwise. The filter 47 includes a frame 49 that is generally circular, and may function as a gasket or a sealing ring. A filtering material 51 is set within the frame 49. In this exemplary filter 47, the filter material 51 is disposed in a concave configuration with the opening of the filter 47 towards the top of the container as the filter 47 is inserted into the container. Alternative configurations of the exemplary filter 47 will be apparent to those skilled in the art.

FIG. 3E illustrates a perspective view of yet another exemplary filter 53 that may be used in a filter apparatus or otherwise. The filter 53 includes a filtering material 55 that may or may not be set within a frame. In this exemplary filter 53, the filtering material 55 is of a generally circular disposition. Around the periphery or perimeter of the filtering material 55 (or frame if included) is a collar 57 that is set generally perpendicular to the filtering material 55. The collar is disposed around the “top” of the filtering material 55 as the filtering material 55 is positioned to be inserted into a container, vessel, or cup. The “height” or “length” of the collar 57 may vary as chosen for any particular use. For example, the height of the collar 57 may match the height of the container in which the filter 53 is disposed. As another example, the height of the collar 57 may be only slight when compared to the height of the container. Alternative configurations of the exemplary filter 53 will be apparent to those skilled in the art.

FIG. 3F illustrates a perspective view of even yet another exemplary filter 59 that may be used in a filter apparatus or otherwise. The filter 59 includes a filtering material 61 that may or may not be set within a frame. In this exemplary filter 59, the filtering material 61 is of a generally circular disposition. Around the periphery or perimeter of the filtering material 61 (or frame if included) is a collar 63 that is set generally perpendicular to the filtering material 61. The collar is disposed around the “top” of the filtering material 61 as the filtering material 61 is positioned to be inserted into a container, vessel, or cup. The “height” or “length” of the collar 63 may vary as chosen for any particular use. In addition, the collar 63 may include a lip 65 disposed around the top of the collar 63. The lip 65, rather than the whole collar 63, (or in addition and as part thereof) may form part of the seal between the filter 59 and the inside surface of the container into which it is inserted.

Effectively, the collar 63 including the lip 65 and the filter material 61 may be configured as a “cup” with a “small wall” or cup “side surfaces” for insertion into the container.

FIG. 3G illustrates a perspective view of even yet another exemplary filter 67 that may be used in a filter apparatus or otherwise. The filter 67 includes a filtering material (only illustrated in part in FIG. 3G) that may or may not be set within a frame. In this exemplary embodiment 67, the filtering material is of a generally circular and flat disposition so as to make up substantially most of the bottom of a cup as configured by the exemplary filter 67. Around the periphery or perimeter of the bottom (such as the bottom of the cup of the filtering material, or frame if included) is a collar 69 that is set generally perpendicular to the filtering material. The collar 69 also may be referred to as a cylindrical attachment. In other words, one end of the cylindrical attachment 69 is attached to the filtering material that serves as the bottom of a “cup”. The collar 69 is disposed around the “top” of the filtering material as the filtering material is inserted into a container, vessel, or cup. The “height” or “length” of the collar 69 may vary as chosen for any particular use. In addition, the collar 69 may include a lip 71 disposed around the top of the collar 69. The lip 71, rather than the whole collar 69, may form part of the seal between the filter 69 and the inside surface of the container into which it is inserted.

Moreover, the lip 71 of the collar 69 may include vents 73a-c etc. (holes, openings, or otherwise) to allow fluid to pass. The vents 73a-c etc. may include filtering material or otherwise. A use of the vents 73a-c may be to return any part of the brewed beverage that gets passed the seal between the filter and the cup to the cup.

Effectively, the collar 69 including the lip 71 (if present) and the filter material may be configured as a “cup” with a “small wall” or cup “side surfaces” for insertion into a container 75 such as illustrated in FIG. 3G. Alternative configurations of the exemplary filter 53 will be apparent to those skilled in the art.

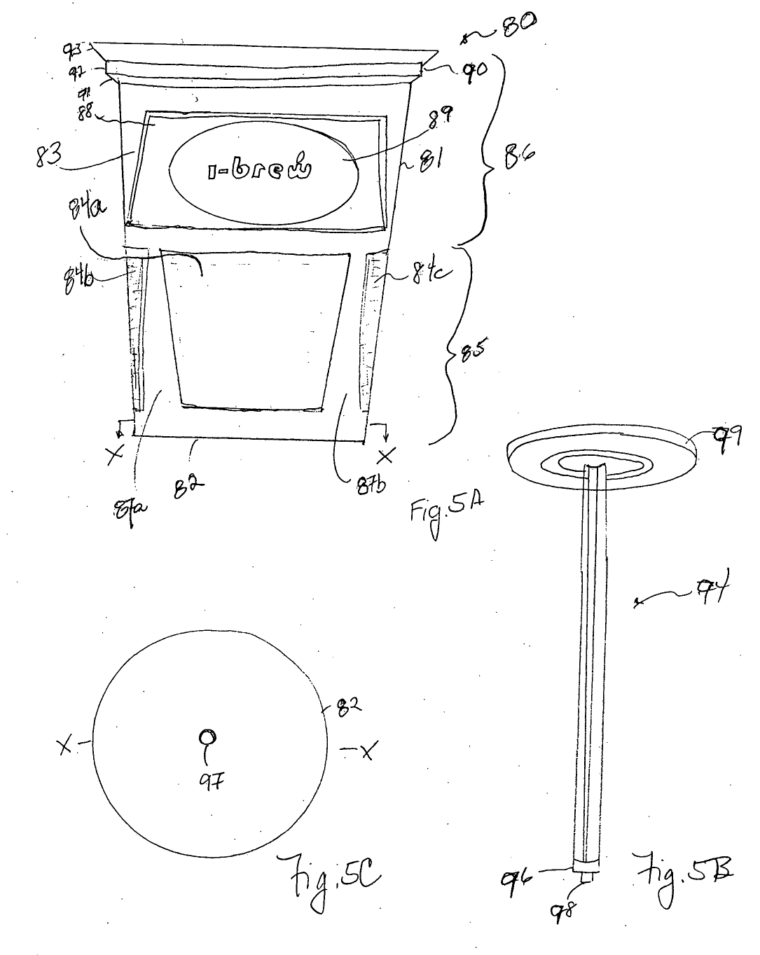

FIG. 4 illustrates another exemplary filter apparatus 46 including a rod 48 and filter 50. The filter 50 provides an additional example of a possible configuration for filtering. The filter 50 is a circular shaped disc of a material such as plastic, cardboard, or other material. The disc is perforated by openings or holes as illustrated by the exemplary holes 52a-b. Advantageously, the filter 50 may be integrally formed without the need for a frame or other supporting device or other the filtering material. Alternatively, the holes 52a-b may be filled with a filtering material.

Examples of a filter as may be used in a filter apparatus have been described herein. The inventions should not be limited to these examples, but may include other configurations for performing the filtering and/or separation functions with respect to a brewed beverage.

As described above, the filter apparatus of the inventions may include a rod connected to the filter, and the rod may be used to insert the filter into the container and to move the filter towards the bottom of the container. The rod may be separable from the filter. The rod also may be used to remove the filter apparatus from the container. In addition, the rod may be used to stir or otherwise mix the brewed beverage. A rod may also be referred to herein as a plunger, a plunger rod, a filter stick, a stick, or like term.

As illustrated in FIGS. 1 and 4, one end of the rod may be attached to the filter. The other end of the rod may be used to insert or otherwise move the filter with respect to the container. The rod, however, may be otherwise attached or separably attached to the filter. For example, the rod may be connected to the filter so that a part of the rod extends below the filter and the remainder of the rod extends above the filter.

Typically, the amount of the rod extending below the filter is less than the amount of the rod extending above the filter, and in an embodiment, may be a small percentage of the overall length of the rod. The part of the rod extending below the filter may serve as a spacer to create a space between the bottom inside of the container and the bottom or underside of the filter. In an exemplary embodiment, the amount of rod extending below the filter may be varied so as to vary the space between the bottom inside of the container and the bottom of the filter. The ability to vary the space is advantageous so as to accommodate different types and/or characteristics of the filtered particles or otherwise.

Further, a rod with part extending below the filter may be used as an aid by the consumer in positioning the filter apparatus inside the container. For example, the consumer may insert the filter apparatus into the container until the consumer feels the part of the rod extending below the filter touch the bottom inside of the container. Optionally, the bottom inside of the container may include a positioning device such as a depression to receive or connect to the tip of the part of the rod extending below the filter. As an example, the bottom inside of the container may include an indentation to receive the referenced tip of the rod.

The filter apparatus 18 shown in FIG. 1 includes a rod 22 connected to the filter 20 at its center. The rod, however, may otherwise be attached or separably attached to the filter. FIG. 4 illustrates a rod 48 that is connected to the filter 50 at a place to one side of the filter 50 closer to the periphery than to the center. Generally, the rod may be connected to the filter in a filter apparatus at a place on the filter that allows the rod to be used by the consumer in using the filter apparatus.

The connection of a rod to a filter may be made in any number of ways. For example, the end of the rod to be separably attached to the filter may include a connection device in a specified shape, such as a cross shape, to fit into a corresponding connection element on the filter.

FIG. 1 illustrates the rod 22 to be in a generally perpendicular position with respect to the filter 20. Nonetheless, a rod may be otherwise positioned such as on an angle.

A rod may be made of the same material as the filter, or part(s) of the filter such as the frame. Alternatively, the rod may be made of a different material. A rod may be integrally formed with the filter, or even with a part(s) of the filter such as the frame. In an embodiment, the connection between the rod and the filter is separable so that, for example, the filter and/or the rod may be used separately. In another embodiment, the connection between the rod and the filter may be such that separation is possible, but not in the ordinary course of use of the filter apparatus.

The rod 22 of FIG. 1 is generally cylindrically shaped, but does not necessarily have to be. The rod 48 of FIG. 4 has a generally square horizontal cross section. Moreover, the rod may have a taper such as rod 48, which has a taper of decreasing size of the horizontal cross section from the end of the rod 48 connected to the filter 50 to the other end of the rod 48 connected to the handle 54.

A rod of a filter apparatus may be hollow, partially hollow, or solid as appropriate to the composition of the rod and to its use as part of the filter apparatus. A rod may be relatively rigid to allow for its use in facilitating the insertion and movement of the filter with respect to the container. The relative rigidity may be such as to prevent breaking or bending of the rod, or to otherwise affect the use of the filter apparatus.

The length of a rod also may be varied depending on a number of factors such as the size of the filter apparatus, and/or of the container in which the filter apparatus may be used, and the type or other characteristics of the liquid and/or the particles. The length of a rod may be set so as to allow for use of the filter apparatus in conventional disposable cups such as may be used with coffee or other beverages.

As illustrated in FIG. 1, the rod 22 has a length such that it rises above the level of a full serving for the container 12 when the filter apparatus is fully inserted and is separating the flavoring residue from the liquid. A rod, however, may be longer or shorter with respect to the container in which the filter apparatus may be used.

The rod 22 of the filter apparatus 18 of FIG. 1 is shown connected to a handle 23 at the end of the rod 22 opposite to the end connected to the filter 20. The handle 23 may facilitate use of the filter apparatus 18 by the consumer. For example, the consumer may hold the filter apparatus 18 by its handle 23. The handle 23 may have other uses as well such as a display function for providing information or advertising. As an example, a trademark for the filter apparatus 18 may be displayed on the top of the handle 23.

In the exemplary embodiment illustrated in FIG. 1, the handle 23 is generally disc shaped, substantially flat, sized slightly larger than the diameter of the rod 22. The handle 23, however, may be almost any shape for ease of grip and each of pushing, such as a knob or ball. The handle 23 is disposed generally perpendicularly to the rod 22. Also in this example, the handle 23 is connected at its center to the rod 22. The handle 23 may be integrally formed with the rod 22. Alternatively, the handle 23 may be separably connected to the rod 22. As yet another alternative, the handle 23 may be separably connected to the rod 22, but such separation is not contemplated in ordinary use of the filter apparatus. The handle 23 may be made of the same or a different material as the rod 22. The handle 23 is generally solid, but does not necessarily have to be.

FIG. 4 illustrates an alternative handle 54 as used with filter apparatus 46. Handle 54 is generally of a square shape and sized larger than a horizontal cross section of the rod 48.

Even though the illustrated examples of filter apparatuses in this description include a handle, a filter apparatus according to the inventions does not have to have a handle. Moreover, a handle may be of a different shape and positioned differently with respect to its rod than the illustrated embodiment.

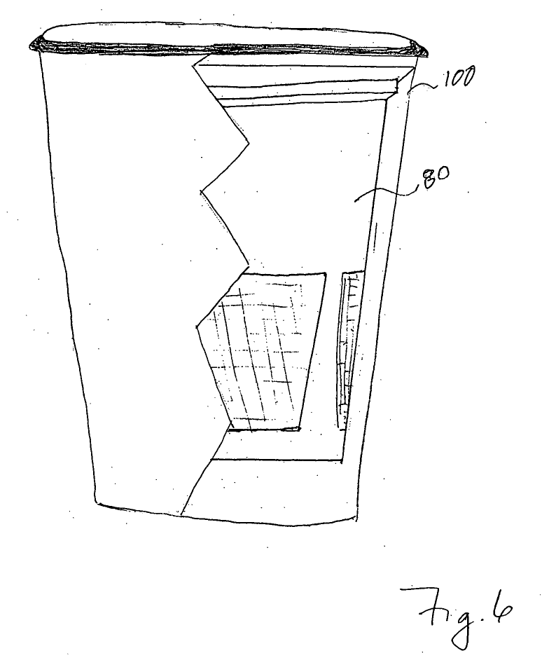

FIGS. 5A-5C illustrate additional exemplary embodiments and exemplary elements of the inventions. For example, FIG. 5A illustrates an exemplary filter 80 that may be used with a container (not illustrated) containing a liquid and particles in the liquid. The exemplary filter 80 includes a cup 81 that may be sized to fit within the container. The illustrated cup 81 is generally cylindrical with a bottom 82 and a cylindrical sidewall 83 that flares out slightly and symmetrically from the bottom 82 to the top of the cup 81. In other words, the sidewall 83 of the cup 81 tapers slightly inward and symmetrically from the top of the cup 81 to its bottom 82. To separate the particles from the liquid in a container, the filter 80 may be inserted into the container. The speed of the insertion may vary depending on the liquid and/or the particles. The liquid is separated from the particles and the filtered liquid may be consumed from the container even with the filter 80 remaining in the container.

The exemplary cup 81 includes material 84a, 84b, and 84c for filtering substantially all of the particles from the liquid in the container and keeping substantially all of the filtered particles separated from the liquid. The embodiment illustrated in FIG. 5A includes the material for filtering only in the sidewall 83 of the cup 81. In the example illustrated in FIG. 5A, the material for filtering is set within a bottom part 85 of the sidewall 83, and in particular, within the bottom half of the sidewall 83 of the cup 81.

Even more particularly, the exemplary embodiment of FIG. 5A illustrates that material for filtering 84a, 84b, and 84c is included in the bottom half of the sidewall 83 of the cup 81 between supports set between the top part 86 of the cup 81 and its bottom 82. The supports may add strength to the overall design of the filter 80. FIG. 5A illustrates two supports 87a, 87b of the four such supports implied relating to four segments of material for filtering set in cup 81. Of the four segments of the material for filtering in the illustrated filter 80, only one complete segment 84a is shown while only parts of two other segments 84b, 84c are shown. In the example of FIG. 5A, a segment of material for filtering is set between a pair of supports disposed between the top part 86 of the cup 81 and its bottom 82.

The material for filtering 84a, 84b, and 84c in filter 80 may be framed into the cup 81 or otherwise. The material for filtering 84a, 84b, and 84c may be in the form of a mesh, screen, sieve, filter material, or the like. The openings in the material for filtering 84a, 84b, 84c for allowing the liquid through, but blocking the particles may be sized as appropriate to the particles to be filtered. The material for filtering 84a, 84b, and 84c may be made of material different from all the rest or some of the elements of the cup 81. In the illustrated embodiment, the material for filtering 84a, 84b, and 84c is made integrally with the cup 81.

As noted above, the bottom part 85 of the cup 81 of the filter 80 may include the material for filtering the particles from the liquid. The top part 86 of the cup may include space for display 88 of information such as a trademark 89, list of ingredients (not illustrated), instructions for use (not illustrated), etc. The space for display may be the inner and/or outer sidewall of the cup 81 in its top part 86. Alternatively, as illustrated in FIG. 5A, the space for display 88 may be set into the sidewall of the cup so as to be differentiated from the inner and/or outer sidewall of the cup 81 in its top part 86. Even if the space for display 88 is differentiated from the inner and/outer sidewall of the cup 81, the space for display may be formed integrally with the top part of the cup 81.

Cup 81 is described herein with reference to the top part 86 of its sidewall 83, which may include a space for display, and to the bottom part 85 of its sidewall 83, which may include the material for filtering. The top part 86 and the bottom part 85 may be separate pieces, may be integrally formed as is the case in the illustrated embodiment of FIG. 5A, or otherwise configured.

The exemplary filter 80 of FIG. 5A includes a gasket 90 disposed around the top of the cup 81 for creating a seal between the cup 81 and the inside side surface of the container into which the filter 80 is placed. Advantageously, the seal prevents the filtered particles from leaving the container when the filtered liquid is consumed or otherwise removed from the container with the filter 80 in place in the container.

In the example illustrated in FIG. 5A, the gasket 90 is about 6-7% of the overall height of the cup 81 and is formed integrally with the cup 81, but these design considerations do not necessarily have to be implemented. In addition, in the example illustrated in FIG. 5A, the gasket 90 is of a three-part quasi-step design, but that also does not necessarily have to be the case. Of the three-part quasi-step design of the gasket 90, as described herein, the first part 91 is next to the top of the cup 81. The first part 91 flares slightly up and away from the outside of the sidewall 83 of the cup 81. A second part 92 of the gasket 90 is set out and up from the sidewall of the cup 81 by the flare of the first part 91 upon which the second part 92 is disposed. The second part 92 is generally collar-like with respect to the cup 81 in that the second part 92 has a flat surface in the direction of the vertical axis of the cup 81. Flaring up and out slightly from the second part 92 of the gasket 90 is the third part 93 of the gasket 90. An advantage of the slight up and outward flare of the third part 93 of the gasket 90 is that the flare allows for a relatively easy creation of a seal between the filter 80 and the container into which the filter 80 may be set. No special features or elements need to be included in a container so as to form a seal with the filter 80. Advantageously, the gasket 90 provides for the seal without any special elements needed in the container. The third part 93 of the gasket 90, as its outermost part, may serve as the rim of the filter 80.

FIG. 5B illustrates a rod 94 (also referred to as a plunger or positioning mechanism) that may be used with the filter 80 illustrated in FIG. 5A. In particular, the rod 94, may be used to insert the cup 81 into a container, to move the cup in the container, and also to remove the cup 81 from the container. In this example, one end 96 of the rod 94 is attached generally perpendicularly to the inside top and substantially center of the bottom 82 of the cup 81. In other words, the rod 94 is generally centered within the cup 81 for ease of use of the filter 80.

To facilitate the use of the rod 94 with the cup 81 in the filter 80, the exemplary embodiment includes a positioning mechanism 97 on the inside top and substantially center of the bottom 82 of the cup 81. The positioning mechanism 97 allows for generally perpendicular attachment of the one end 96 of the rod 94 to the approximate center of the bottom 82 of the cup 81. In particular, the positioning mechanism 97 may be a female device designed for receipt of a male device 98 on the end 96 of the rod 94. Positioning of the male device 98 in the female device 97 results in attachment of the rod 94 to the cup 81. The attachment may be releasable. For example, the rod 94 may be released from the cup 81 by gently twisting the rod 94 to the right or to the left with respect to the cup 81 and pulling the rod 94. The rod 94 may be used independently of the cup 81 such as to stir the filtered liquid in the container.

To further facilitate the use of the filter 80, the rod 94 may include a handle 99 opposite to the end 96 of the rod 94 that may be attached to the bottom 82 of the cup 81. The handle 99 may have myriad uses. The handle 99 may be used to facilitate attachment of the rod 94 to the positioning mechanism 97 on the top of the bottom 82 of the cup 81. The handle 99 may be used to insert the filter 80 into, move it within, and to remove it from the container. The handle 99 may be used in using the rod 94 even when the rod 94 is separated from the cup 81.

As illustrated in FIG. 5B, the handle 99 of the rod 94 of the exemplary embodiment is a generally flat oval centered over the rod 94. The oval face is disposed generally perpendicularly to the rod 94. The generally flat oval shape and size of the handle 99 allows for a two-fingered-plus-thumb use of the handle 99. The handle 99 is generally sized so that an index and middle finger of a hand may be placed under the handle 99 and on opposite sides to the rod 94. The thumb of the same hand may be placed on top of the handle 99. The position of the thumb on top of the handle 99 and the two fingers underneath the handle 99 allows for ease in positioning the rod 94, and the filter 80 if the rod 94 is attached to the cup 81.

In addition, the handle 99 may serve other functions as part of the filter 80. Referring to the exemplary embodiment illustrated in FIG. 5B, the top of the handle 99 may include an indicator surface (not illustrated) for display of information such as a trademark, list of ingredients, instructions, etc. The handle 99 also may serve as an indicator with respect to the position of the filter 80 in the container. For example, reference is again made to FIG. 5B where the handle 99 includes a generally flat top set perpendicularly to the rod 94. If the filter 80 with the attached handle 99 is fully inserted into the container, the resulting position of the handle 99 may indicate the position of the filter 80 with respect to the container. If the handle 99 is generally disposed in a parallel plane to the bottom 82 of the cup 81 of the filter 80, the filter 80 may be considered to be generally levelly disposed within the container. If the handle 99 is skewed, however, with respect to being parallel to the bottom 82 of the cup 81, then the filter 80 may be in a skewed position within the container.

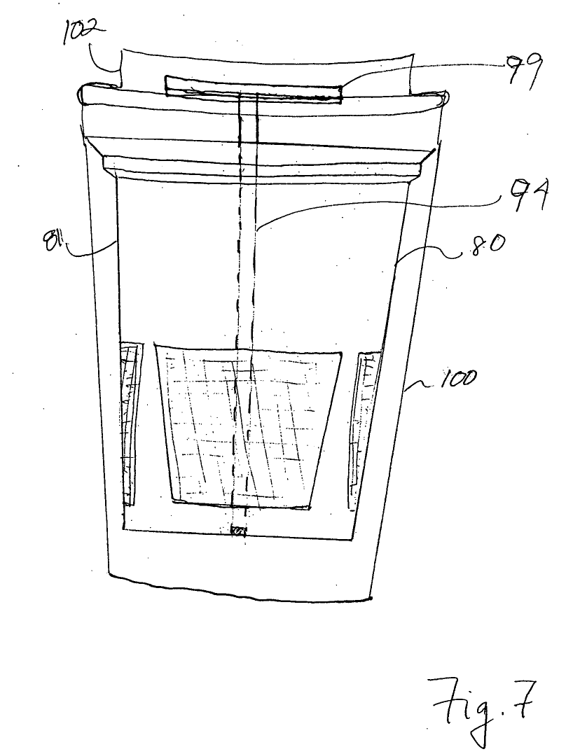

FIG. 6 illustrates how an exemplary filter 80 of the inventions may be used with a container 80. FIG. 6 depicts a filter 80 set into a container 80 with the container 80 shown in cutaway so as to illustrate the general position of the filter 80 within the container 80. This example illustrates the filter 80 may be used without a rod such as rod 94 illustrated in FIG. 5B or otherwise.

FIG. 7 also illustrates the exemplary filter 80 set into the container 80, but with the rod 94. Advantageously, the cup 81 and the rod 94 of the filter 80 are sized to fit within the container 100. Advantageously, the filter 80 including the rod 94 is sized to allow placement of a cover 102 (also referred to as a lid) over the container 100. A further advantage is that the filter 80 may be used with containers and covers that may be of conventional size.

Other features and advantages of the inventions may be more clearly understood and appreciated from a review of the following detailed description and by reference to the appended drawings and claims.

I claim:

1. A filter for use in a container containing a liquid and particles in the liquid, the filter comprising:
a cup sized to fit within the container
with the cup including a generally cylindrical sidewall attached at one end to the bottom of the cup,
with the sidewall of the cup also including material for filtering substantially all of the particles from the liquid and keeping substantially all of the filtered particles separated from the liquid, and
with the cup having a gasket disposed around the top of the cup for creating a seal between the cup and the inside side surface of the container; and
a rod with one end of the rod attached generally perpendicularly to the inside top and substantially center of the bottom of the cup.

2. The filter of claim 1, wherein only the sidewall of the cup includes the material for filtering.

3. The filter of claim 1, wherein the sidewall includes the material for filtering only in its bottom half.

4. The filter of claim 1, wherein the sidewall of the cup tapers slightly inward from the gasket of the cup to the bottom of the cup.

5. The filter of claim 1, wherein the material for filtering is included in the bottom half of the sidewall of the cup between supports set between the top half of the sidewall of the cup and the bottom of the cup.

6. The filter of claim 5, wherein the material for filtering comprises at least two segments;
wherein the supports set between the top half of the generally cylindrical side wall of the cup and the bottom of the cup comprise at least two supports; and
wherein the at least two segments are included, respectively, between the at least two supports.

7. The filter of claim 1, wherein the gasket is integrally formed with the cup.

8. The filter of claim 1, wherein the gasket comprises three parts.

9. The filter of claim 1, wherein the cup comprises a positioning mechanism on the inside top and substantially center of the bottom of the filter cup for generally perpendicular attachment of the one end of the rod.

10. The filter of claim 9, wherein the positioning mechanism comprises a female device for receipt of a male device on the one end of the rod.

11. The filter of claim 1, wherein the rod comprises a handle at the end opposite to the one end of the rod attached to the bottom of the cup with the handle comprising an indicator surface for display of information.

12. The filter of claim 1, wherein the rod is removable from the cup.

13. The filter of claim 1, wherein the cup with the attached rod is sized to fit within the container.

14. The filter of claim 1, wherein the cup with the attached rod is sized to fit the container to allow placement of a cover over the container.

15. An apparatus for filtering a fluid of a substance, comprising:
a cup including a generally cylindrical sidewall connected to a bottom with the sidewall tapering slightly outwardly away from the bottom towards the top of the sidewall; and
the sidewall of the cup including filter material set in at least part of the bottom part of the sidewall,
whereby insertion of the cup into the fluid including the substance filters the fluid of the substance by the cup allowing the fluid but not the substance to pass through the sieving material.

16. The apparatus of claim 15, wherein the cup comprises a gasket disposed around the top of the sidewall of the cup.

17. The apparatus of claim 15, further comprising a plunger removeably attached to the inside top of the bottom of the cup.

18. A filter for use in brewing a beverage from liquid and a brewing substance, comprising:
a device for separating the brewing substance from the liquid with the device including a bottom attached to a collar,
with the collar framing at least one segment of filter material; and
a plunger attached to the inside top of the bottom of the device for inserting the device into the liquid and removing the device from the liquid.

19. The filter of claim 18, wherein the positioning mechanism is detachable.
